(19) United States
(12) Patent Application Publication
(10) Pub. No.: US 2023/0008548 A1
(43) Pub. Date: Jan. 12, 2023

(54) GAMING SYSTEMS AND METHODS FOR PROGRESSIVELY DECREMENTING FEATURE UNLOCK REQUIREMENTS

(71) Applicant: IGT, Las Vegas, NV (US)

(72) Inventor: David Wright, Streethay (GB)

(21) Appl. No.: 17/370,091

(22) Filed: Jul. 8, 2021

(51) Int. Cl. G07F 17/32

(52) U.S. Cl. CPC G07F 17/3269; G07F 17/3227; G07F 17/3244; G07F 17/3213

(57) ABSTRACT

The present disclosure relates generally to systems and methods for progressively decrementing unlock requirements for a game feature of a base game based on wagers made on the game. The game feature corresponds to in-game opportunities such as incorporating special symbols and multipliers or to other games, jackpots, or progressives that increase the chances of winning for a player using the game feature. As wagers, for example, into a wager pool the amount required to unlock the game feature is progressively reduced, or decremented over time. The amount is decremented by some proportion of the wagers made in the wager pool. As the wagers increase, the amount required to unlock the game feature decreases until the game feature is unlocked.

### BACKGROUND

The present disclosure is generally directed to gaming systems and, in particular, toward gaming systems that provide unlockable gaming features.

Gaming machines typically offer a number of built-in game play features that contribute to the overall player experience. Any type of game play feature that presents the player with an additional opportunity to win is often viewed as desirable and can lead to increased play of the gaming machine.

### BRIEF SUMMARY

In certain embodiments, the present disclosure relates to a device, method, and system that provides a progressively reducing gaming feature purchase opportunity for grid-based (e.g., reel-spin, matching, etc.) gaming devices. In some embodiments, a gaming device is provided, comprising: a display device; a processor coupled to the display device; and a memory coupled with and readable by the processor and storing therein instructions that, when executed by the processor, cause the processor to: execute a base game at the gaming device that provides a first interactive gaming behavior comprising a first determined chances of winning for the base game while a game feature for the base game is in a locked state; maintain the game feature for the base game in the locked state until an unlocking input is received comprising a predetermined amount that, when provided as a credit received from a credit meter, unlocks the game feature for the base game, wherein the game feature provides a second interactive gaming behavior comprising a second determined chances of winning for the base game greater than the first determined chances of winning when the game feature is in an unlocked state; decrement, based on wagers made in a feature pool during plays of the base game, the predetermined amount to successively decreased values as long as the game feature remains in the locked state between each play of the plays of the game; and render, by the display device at each play of the plays of the game, a last successively decreased value for the predetermined amount to unlock the game feature for the base game.

In some embodiments, a method is provided, comprising: executing, by a processor, a base game at a gaming device that provides a first interactive gaming behavior comprising a first determined chances of winning for the base game while a game feature for the base game is in a locked state; maintaining, by the processor, the game feature for the base game in the locked state until an unlocking input is received comprising a predetermined amount that, when provided as a credit received from a credit meter, unlocks the game feature for the base game, wherein the game feature provides a second interactive gaming behavior comprising a second determined chances of winning for the base game greater than the first determined chances of winning when the game feature is in an unlocked state; decrementing, by the processor and based on wagers made in a feature pool during plays of the base game, the predetermined amount to successively decreased values as long as the game feature remains in the locked state between each play of the plays of the game; and causing to render, by a display device of the gaming device at each play of the plays of the game, a last successively decreased value for the predetermined amount to unlock the game feature for the base game.

In some embodiments, a system is provided, comprising: a processor; and a computer-readable storage medium, coupled with the processor, comprising instructions that are executable by the processor, wherein the instructions comprise: instructions that execute a base game at a gaming device that provides a first interactive gaming behavior comprising a first determined chances of winning for the base game while a game feature for the base game is in a locked state; instructions that maintain the game feature for the base game in the locked state until an unlocking input is received comprising a predetermined amount that, when provided as a credit received from a credit meter, unlocks the game feature for the base game, wherein the game feature provides a second interactive gaming behavior comprising a second determined chances of winning for the base game greater than the first determined chances of winning when the game feature is in an unlocked state; instructions that decrement, based on wagers made in a feature pool during plays of the base game, the predetermined amount to successively decreased values as long as the game feature remains in the locked state between each play of the plays of the game; and instructions that cause to render, by a display device at each play of the plays of the game, a last successively decreased value for the predetermined amount to unlock the game feature for the base game.

Additional features and advantages are described herein and will be apparent from the following Description and the figures.

### BRIEF DESCRIPTION OF THE SEVERAL VIEWS OF THE DRAWINGS

FIG. 1A depicts one example of a computational gaming device used in progressively decrementing unlock requirements for a game feature of a base game;

FIG. 1B depicts another example of a computational gaming device used in progressively decrementing unlock requirements for a game feature of a base game;

FIG. 2 is a block diagram depicting components of a computational gaming device for progressively decrementing unlock requirements for a game feature of a base game;

FIG. 3 is an illustrative layout of symbols rendered to an array of cells of a grid-based game;

FIG. 4 is a block diagram of a competitive gaming system for progressively decrementing unlock requirements for game features between linked gaming devices;

FIG. 5A is a schematic diagram of a screen of a gaming device in a segmented presentation for rendering information to a player;

FIG. 5B is a representative image of a screen of a gaming device comprising an arrangement of windows with one window displaying game information and other windows displaying settings and game feature unlock information for a base game;

FIG. 6A illustrates a first window providing game feature unlock information and player-selectable options to unlock and activate a game feature for a base game;

FIG. 6B illustrates a second window providing game feature unlock information and player-selectable options to unlock and activate a game feature for a base game;

FIG. 7 is a block diagram of a data structure used in progressively decrementing unlock requirements for game features in a base game;

FIG. 8 is a flow diagram of a first example process for progressively decrementing unlock requirements for game features in a base game; and

FIG. 9 is a flow diagram of a second example process for progressively decrementing unlock requirements for game features in a base game.

### DETAILED DESCRIPTION

Embodiments of the present disclosure will be described in connection with gaming systems having one or multiple gaming devices that are capable of providing progressively decrementing unlock requirements for a game feature of a base game (e.g., a grid-based game, etc.) based on wagers made in wager pool. The game features may correspond to bonus features such as scatters or scatter symbols, chances at progressives, chances at a jackpot, wild symbols, multipliers (e.g., symbols or spin related), additional paylines, additional reels, bonuses, additional (e.g., free) spins, mini-games, etc., and/or combinations thereof. In any event, the game features may be related to in-game opportunities and/or related to other games, jackpots, or progressives. As wagers are made into a wager pool (e.g., as games are played at one or more gaming devices, etc.), the cost or amount required to purchase, or unlock, the game feature is progressively reduced, or decremented. In some embodiments, the amount may be decremented by a proportion of the wagers in the wager pool. As the wagers increase, the amount required to unlock the game feature may decrease until the game feature is unlocked. Providing players with the ability to buy a game feature for progressively reduced costs allows a player to control their chances of winning and alter the proposed payouts for winning sequences of symbols for at least one subsequent play having the game feature activated. The gaming devices may comprise a computational device, such as a slot machine or Electronic Gaming Machine (EGM), that implements a sliding symbol and subsequent play operation. While embodiments of the present disclosure will be described in connection with the example of a slot machine, or EGM implementing sliding symbol operations, it should be appreciated that embodiments of the present disclosure are not so limited. For instance, other types of computational devices, such as portable user devices, smartphones, tablets, laptops, Personal Computers (PCs), wearable devices, etc. may be used to implement game enhancement features as part of a game as described herein. Furthermore, it should be appreciated that embodiments of the present disclosure may apply to games other than slot games. For instance, embodiments of the present disclosure may be used in connection with any type of grid-based game such as bingo, keno, slots, matching games, table games, etc.

It is an aspect of the present disclosure that a player may buy a game feature (e.g., bonus, etc.) on the game either individually, such as purchasing three scatters, four scatters, five scatters, or some other bonus such as a chance at a progressive of jackpot. In one embodiment, the cost of buying the bonus reduces every spin by a proportion of the stake. Rather than operate like a progressive (where all the pots increase by a proportion of the stake every spin), the methods described herein my operate like an “inverse progressive” where the cost of buying the feature(s) would reduce by a proportion of the stake on every spin.

In some embodiments, if the cost of one of the features hit zero, then the feature may automatically trigger after the spin that reduced the cost to zero. If multiple features hit zero after one credit, the multiple features would all be awarded consecutively starting with the lowest cost feature (e.g., the one that costs the least one reset).

In one embodiment, after a feature is bought, or awarded by reaching zero cost, the cost to buy may reset to the default amount.

In one embodiment, multiple gaming devices (e.g., EGMs, etc.) may be linked in a gaming system and, when wagers are made by different players (e.g., into a wager pool), all of the players in the gaming system are reducing the cost required to unlock the game feature. As the cost to unlock the game feature reduces, the first player to pay the reduced amount is allowed to unlock the game feature for use in a base game. In this example, the cost to unlock the game feature for other players may reset to an undecremented, or unreduced, amount. In some embodiments, while a game feature is enabled for a player (e.g., at the base game executed by the gaming device of the player), that player may be prevented from purchasing another game feature at a reduced cost or amount. In some embodiments, the cost may reduce every spin and the cost may be specific to the stake and denomination at every spin. Among other things, embodiments of the present disclosure provide a player with more ways to win a game, the ability to alter the chances of winning in a game, the ability to alter the payout amount for a winning game outcome, and add excitement to the overall game-playing experience of grid-based games by, for example, competing with others in racing to unlock game features first.

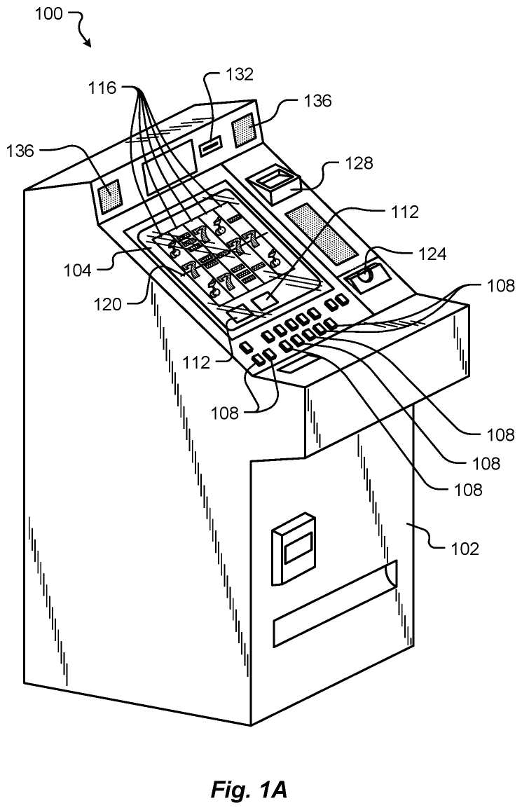

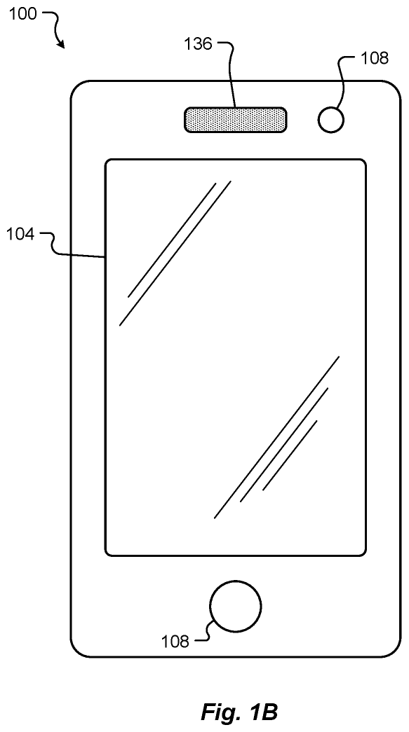

With reference now to FIGS. 1A and 1B, an illustrative computational device 100 that may be used to implement a grid-based game or the like will be described in accordance with at least some embodiments of the present disclosure. A computational device 100 may include a portable or non-portable device used for executing a gaming application or multiple different gaming applications without departing from the scope of the present disclosure. Non-limiting examples of a computational device include an EGM, a Video Gaming Machine (VGM), a mobile communication device (e.g., a smartphone, laptop, tablet, wearable device, etc.), a personal computer (PC), etc. An EGM or VGM-type of computational device 100 is shown in FIG. 1A in accordance with embodiments of the present disclosure.

The illustrative computational device 100 of FIG. 1A is shown to include a support structure, housing or cabinet, 102 which provides support for a plurality of displays, inputs, controls and other features of a conventional gaming machine. In the illustrated embodiment, a player plays the computational device 100 while sitting, however, the computational device 100 is alternatively configured so that a player can operate it while standing or sitting. The illustrated computational device 100 is positioned on the floor but can be positioned alternatively (i) on a base or stand, (ii) as a pub-style table-top game (e.g., where the participant computational devices are located remotely from the shared wheel as discussed below), (iii) as a stand-alone computational device on the floor of a casino with other stand-alone computational devices, or (iv) in any other suitable manner. The computational device 100 can be constructed with varying cabinet and display configurations.

In one embodiment, a computational device 100 is configured to randomly generate awards and/or other game outcomes based on probability data. Since a computational device 100 generates outcomes randomly or based upon a probability calculation, there is no certainty that the computational device 100 will provide the player with any specific award or other game outcome.

In some embodiments, a computational device 100 may employ a predetermined or finite set or pool of awards, progressive awards, prizes or other game outcomes. As each award or other game outcome is provided to the player, the computational device 100 removes the provided award or other game outcome from the predetermined set or pool. Once removed from the set or pool, the specific provided award or other game outcome cannot be provided to the player again. The computational device 100 provides players with all of the available awards or other game outcomes over the course of the play cycle and guarantees a designated number of actual wins and losses.

The computational device 100 may include one or more displays 112. An illustrative display 112 may include a credit display that displays a player's current number of credits, cash, account balance or the equivalent. Another illustrative display 112 may include a bet display that displays a player's amount wagered.

The computational device 100 is also shown to include at least one payment acceptor. Illustrative payment acceptors may include, without limitation, a coin slot 124, where the player inserts coins or tokens, and a ticket, note, or bill acceptor 128, where the player inserts a bar-coded ticket, note, or cash. In one embodiment, a player-tracking card, credit card, debit card, or data card reader/validator 132 is also provided for accepting any of those or other types of cards as a form of payment toward playing a game on the computational device 100.

In one embodiment, a player inserts an identification card into card reader 132 of computational device 100. The identification card can be a smart card having a programmed microchip or a magnetic strip coded with a player's identification, credit totals, and other relevant information. In one embodiment, money may be transferred to computational device 100 through an electronic fund transfer and card reader 132 using the player's credit, debit, or smart card. When a player funds the computational device 100, a processor of the computational device 100 may determine the amount of funds entered and the corresponding amount is shown on the credit or other suitable display 112 as described above.

In one embodiment, after appropriate funding of computational device 100, the player presses an input device 108 to initiate game play. The input devices 108 may include various types of buttons, levers, gesture inputs, cameras, etc., that enable a player to start any game play or sequence of events. In one embodiment, upon appropriate funding, computational device 100 begins game play automatically. In another embodiment, the player needs to actuate or activate one of the play buttons to initiate play of computational device 100. Other non-limiting types of input devices 108 may include a “bet one” button, a “max bet” button, or any other type of button known to be included in an EGM, VGM, or the like. It should further be appreciated that the input devices 108 may correspond to a physical button, a virtual button on a touch-screen of a game, an input element on a Graphical User Interface (GUI), or a combination thereof. In other words, the input devices 108 do not need to correspond to a physical button. In some embodiments, the player places a bet by pushing a “bet one” button (e.g., betting an amount equal to one credit for the next play). The player may increase the player's wager by one credit each time the player pushes “bet one” button. When the player pushes the “bet one” button, the number of credits shown in the credit display decreases by one, and the number of credits shown in the bet display increases by one. A “max bet” button can also be provided, which enables the player to bet the maximum wager (e.g., max lines, max wager per line, and re-spin operation). The computational device 100 may include other suitable wager buttons, such as a “repeat bet” button (e.g., repeating the bet made from the immediately last play of the computational device 100 for the next play of the computational device 100), one or more “select paylines” buttons, a “select re-spin operation” button, and one or more “select wager per payline” buttons.

Another type of input device 108 that may be provided on the computational device 100 is a physical cash out button, a virtual cash out button, a selectable GUI element, or the like. The player presses a cash out button and cashes-out to receive a cash payment or other suitable form of payment corresponding to the number of remaining credits. The player can receive coins or tokens in a coin payout tray or a ticket or credit slip, which are redeemable by a cashier or funded to the player's electronically-recordable identification card.

The computational device 100 may also include one or more display screens 104 and one or more sound generating devices 136. The combination of outputs provided on a display screen 104 and sound generating device 136 may contribute to the game play experience and, in some embodiments, may provide the player with information regarding a status of a game play event or sequence of events.

In one embodiment, the sound generating device 136 may include at least one speaker or other type of transducer for generating audible sounds, playing music, etc. In one embodiment, a computational device 100 provides dynamic sounds coupled with attractive multimedia images displayed on the display screen 104 to provide an audio-visual representation or to otherwise display full-motion video with sound to attract players to the computational device 100. During idle periods, the computational device 100 displays a sequence of audio and/or visual attraction messages to attract potential players to the computational device 100.

In one embodiment, a base or primary grid-based game includes a slot game with one or more paylines 120. As will be discussed in further detail herein, the grid-based game provided by the computational device 100 may support one or multiple paylines 120, which may extend across the display screen 104 vertically, horizontally, diagonally, at adjusted angles, etc. In some embodiments, such as for a slot game, a payline 120 intersects a plurality of reels 116, such as three to five reels. Each reel 116 of the display screen 104 may be used to display different sets of symbols in connection with game play activity provided by the computational device 100. In some embodiments, each reel 116 may operate independent of all other reels and the symbols displayed by a reel 116 at the end of a given spin may depend upon random numbers generated by the computational device 100. The positions of symbols on each reel 116 and in the combination of reels 116 may form the array of cells in the presentation order rendered to the display screen 104 of the computational device 100.

The reels 116 may be provided in video form with simulated reels being displayed via the display screen 104. A reel 116 may be used to display any number of symbols such as bells, hearts, fruits, numbers, letters, bars or other images and symbols, which preferably correspond to a theme associated with a game provided by the computational device 100. With a slot game, the computational device 100 may be configured to award prizes, awards, or other game play opportunities when the reels 116 stop spinning and a predetermined symbol combination lands across an active payline 120 (e.g., a payline 120 that is currently being wagered and is subject to evaluation for a win after the reels 116 have stopped spinning).

FIG. 1B illustrates another example of a computational device 100 in accordance with at least some embodiments of the present disclosure. This particular example of computational device 100 may correspond to a portable computational device 100 such as a mobile smartphone, tablet, wearable, etc. The computational device 100 may be owned by a user of the device 100 rather than being owned by a casino operator.

The computational device 100 again includes a display screen 104, a plurality of input devices 108, and at least one speaker 136. In some embodiments, the display screen 104 may correspond to a touch-sensitive display screen, meaning that the display screen 104 is simultaneously capable of displaying information (e.g., in connection with game play activity) and receiving a user input. In some embodiments, the touch-sensitive display screen 104 may provide game features similar to a cabinet-style computational device 100 without requiring all of the dedicated buttons provided by a cabinet-style computational device 100.

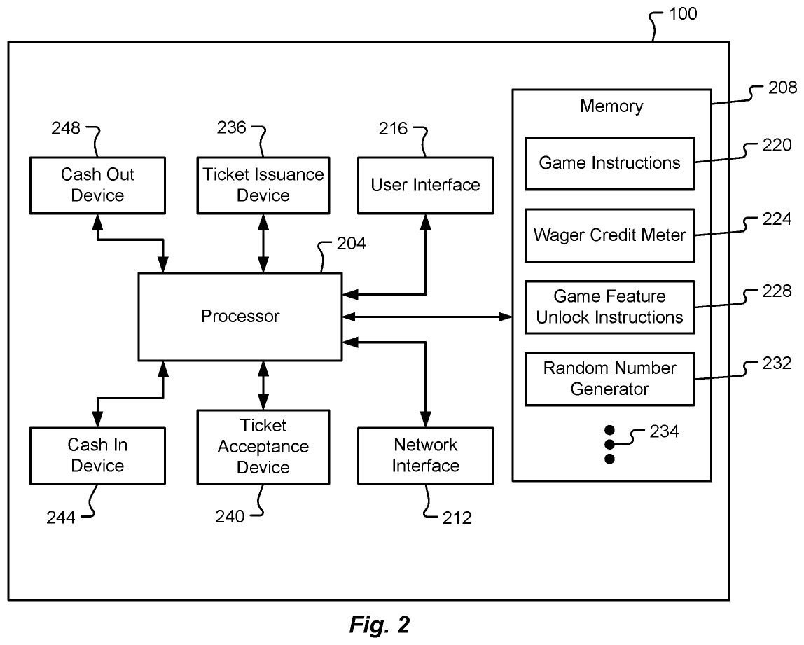

With reference now to FIG. 2, additional details of the components that may be included in a computational device 100 will be described in accordance with at least some embodiments of the present disclosure. The computational device 100 is shown to include a processor 204, memory 208, a network interface 212, and a user interface 216. In some embodiments, the processor 204 may correspond to one or many microprocessors, Central Processing Units (CPUs), microcontrollers, Integrated Circuit (IC) chips, or the like. The processor 204 may be configured to execute one or more instruction sets stored in memory 208. In some embodiments, the instruction sets stored in memory 208, when executed by the processor 204, may enable the computational device 100 to provide game play functionality.

The nature of the network interface 212 may depend upon whether the network interface 212 is provided in cabinet-style computational device 100 or a mobile computational device 100. Examples of a suitable network interface 212 include, without limitation, an Ethernet port, a Universal Serial Bus (USB) port, an RS-232 port, an RS-485 port, a network interface controller (NIC), a Slot Machine Interface Board (SMIB) an antenna, a driver circuit, a modulator/demodulator, etc. The network interface 212 may include one or multiple different network interfaces depending upon whether the computational device 100 is connecting to a single communication network or multiple different types of communication networks. For instance, the computational device 100 may be provided with both a wired network interface 212 and a wireless network interface 212 without departing from the scope of the present disclosure.

The user interface 216 may include a combination of the user input and user outputs described in connection with FIGS. 1A and 1B. For instance, the user interface 216 may include the display screen 104, the input devices 108, the speakers 136, or any other component that is capable of enabling user interaction with the computational device 100. The user interface 216 may also include one or more drivers for the various hardware components that enable user interaction with the computational device 100.

The memory 208 may include one or multiple computer memory devices that are volatile or non-volatile. The memory 208 may be configured to store instruction sets that enable player interaction with the computational device 100 and that enable game play at the computational device 100. Examples of instruction sets that may be stored in the memory 208 include a game instruction set 220, a credit meter 224, and a game feature unlock instruction set 228. In addition to the instruction sets, the memory 208 may also be configured to store a random number generator 232 that is used by the game instruction set 220, for example, to provide game outputs.

In some embodiments, the game instruction set 220, when executed by the processor 204, may enable the computational device 100 to facilitate one or more games of chance or skill and produce interactions between the player and the game of chance or skill. In some embodiments, the game instruction set 220 may include subroutines that present one or more graphics to the player via the user interface 216, subroutines that calculate whether a particular wager has resulted in a win or loss during the game of chance or skill, subroutines for determining payouts for the player in the event of a win, subroutines for exchanging communications with another device, such as a server, subroutines for determining random slidable symbol appearances during game play, and any other subroutine useful in connection with facilitating game play at the computational device 100.

In some embodiments, the game instruction set 220 may include instructions that initiate a reel spin at the various reels 116 in connection with game play. In some embodiments, the random number generator 232 is used to determine a final position of the reels 116 after the spin is completed. The game instruction set 220 may also be configured to present symbols via the display screen 104 when the reels 116 correspond to video reels or the like. The game instruction set 220 may also be configured to evaluate a position of symbols relative to one or more paylines 120, relative to predetermined symbol areas, or cells in an array of cells, and any other evaluation desired to facilitate game play.

The credit meter 224 may correspond to an instruction set within the computational device 100 that facilitates a tracking of wager activity at the computational device 100. In some embodiments, the credit meter 224 may be used to store or log information related to various player activities and events that occur at the computational device 100. The types of information that may be maintained in the credit meter 224 include, without limitation, player information, available credit information, wager amount information, and other types of information that may or may not need to be recorded for purposes of accounting for wagers placed at the computational device 100 and payouts made for a player during a game of chance or skill played at the computational device 100.

In some embodiments, the credit meter 224 may be configured to track coin in activity, coin out activity, coin drop activity, jackpot paid activity, credits applied activity, external bonus payout activity, voucher in activity, voucher out activity, timing of events that occur at the computational device 100, and the like. In some embodiments, certain portions of the credit meter 224 may be updated in response to outcomes of a game of chance or skill played at the computational device 100.

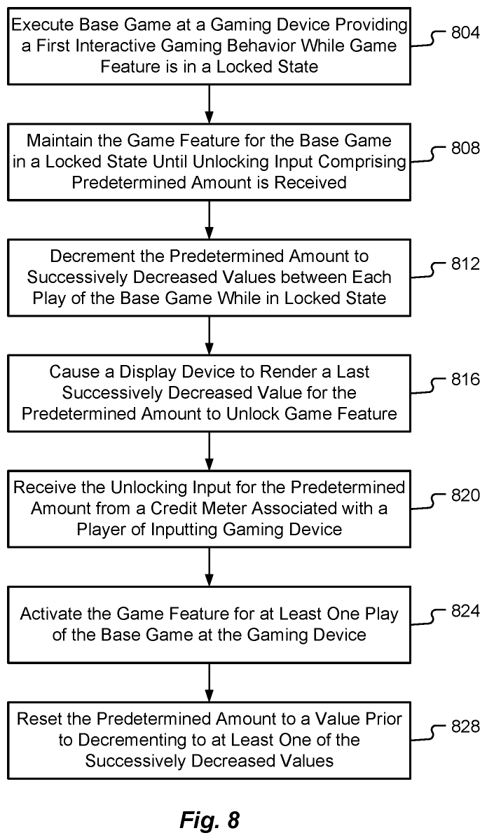

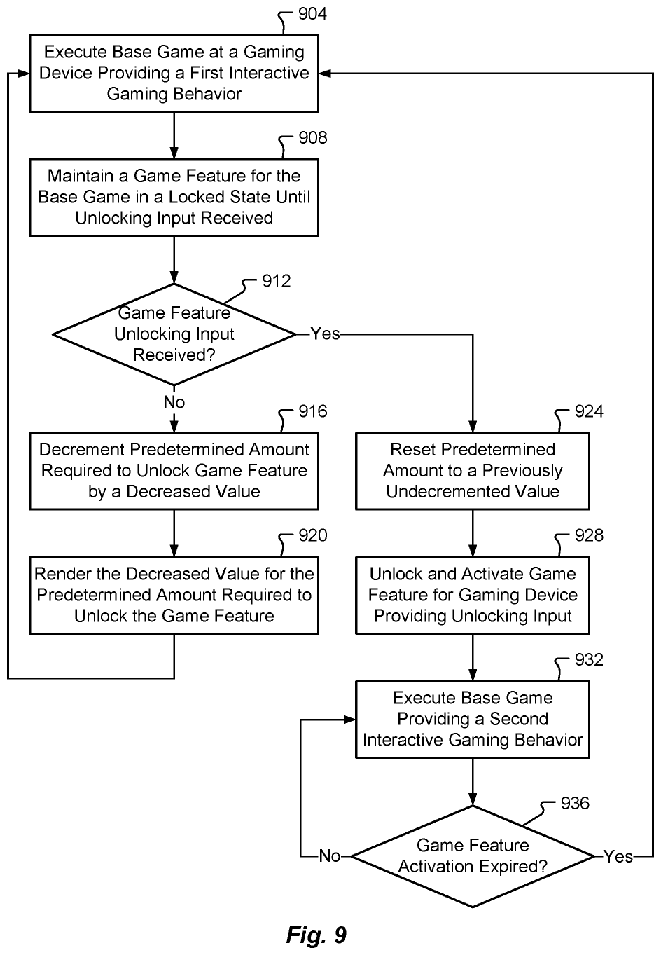

The game feature unlock instruction set 228 may correspond to a subroutine that is called by the game instruction set 220 during game play. In some embodiments, the game feature unlock instruction set 228 may be called by the game instruction set 220 when the game instruction set determines that a game feature (e.g., scatters or scatter symbols, chances at progressives, chances at a jackpot, wild symbols, multipliers (e.g., symbols or spin related), additional paylines, additional reels, bonuses, additional (e.g., free) spins, mini-games, etc.) is available for activation upon providing an unlocking input. The unlocking input may correspond to a payment, or transfer of credits from the credit meter 224, to unlock the game feature. Once unlocked, the game feature may be activated for one or more subsequent plays at the computational device 100. In some embodiments, the game feature unlock instruction set 228 is configured, when executed by the processor 204, to prompt a player for an unlocking input (e.g., by causing a window to render to the user interface 216 with unlocking information, predetermined unlock values, etc.). The game feature unlock instruction set 228 may further receive the unlocking input (e.g., by the player selecting an icon or other portion of the user interface 216 indicating that the player wishes to unlock the game feature identified). In response, the game feature unlock instruction set 228 may inform the game instruction set 220 of the game feature to unlock and activate during a subsequent game play (e.g., a re-spin operation, etc.). The game instruction set 220 can then implement a re-spin operation while maintaining the slidable symbol in the dragged-to cell chosen by the player and received by the symbol slide instruction set 228. When activated, or in an unlocked state, the game instruction set 220 and/or the game feature unlock instruction set 228 may enable the game feature by providing a different interactive gaming behavior for the base game (e.g., providing greater chances of winning the base game compared to the chances of winning the base game when the game feature is in a locked state). It is the cooperation of the game instruction set 220 and game feature unlock instruction set 228 that helps increase the desirability of the overall gaming experience and that gives a player the sense of control over the game that may increase their desire to continue playing the computational device 100. Examples of the operations provided by the game feature unlock instruction set 228 may be described at least in conjunction with FIGS. 8 and 9.

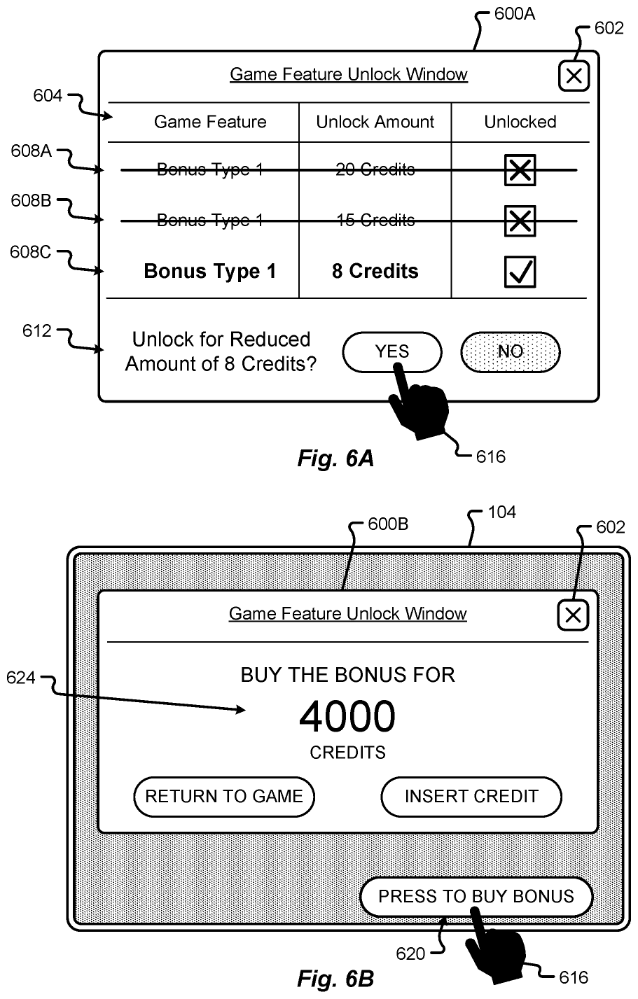

While shown as separate instruction sets, it should be appreciated that the game feature unlock instruction set 228 may correspond to a subroutine of the game instruction set 220 without departing from the scope of the present disclosure. Additional details and functional capabilities of the game feature unlock instruction set 228 working in cooperation with the game instruction set 220 will be described in connection with FIGS. 6-9.

The computational device 100 is further shown to include a ticket issuance device 236, a ticket acceptance device 240, a cash in device 244, and a cash out device 238. The ticket issuance device 236 may be configured to receive physical tickets, vouchers, or player loyalty cards. In some embodiments, the ticket issuance device 236 and ticket acceptance device 240 may operate in concert with the ticket acceptor 128. In such an embodiment, the ticket acceptor 128 may correspond to the physical components that receive and issue a ticket or voucher whereas the ticket issuance device 236 and the ticket acceptance device 240 correspond to the drivers and/or firmware components that control operation of the ticket acceptor 128. It should also be appreciated that the card reader 132 may be in communication with the ticket issuance device 236 and the ticket acceptance device 140 and may have functionality driven by one or both of these devices. For instance, the card reader 132 may correspond to the physical hardware components that receive information from a player loyalty card (or player loyalty application running on a mobile communication device, etc.) and that information may be processed by the ticket acceptance device 240 when receiving player credits from cards read by the card reader 132. The ticket issuance device 236 may provide the card reader 132 with information for applying wager credits back to a player card when a player is done with a game play session and wishes to transfer credits from the credit meter 224 back onto their card. Thus, the ticket issuance device 236 and ticket acceptance device 240 may also operate as a driver and/or firmware component for the card reader 132.

Similarly, the cash in device 244 and cash out device 248 may include or operate in concert with the coin slot 124 and any coin delivery mechanisms. The cash in device 244 and cash out device 248 may include hardware, drivers, or firmware that facilitate receiving or distributing cash, tokens, bills, etc. In some embodiments, the cash in device 244 may be configured to determine an amount of cash (e.g., in coins, bills, etc.), an amount or number of tokens, etc., input at the coin slot 124 and convert the values into credits for playing games with the game instruction set 220. The cash out device 248 may correspond to hardware and software configured to output coins, tokens, bills, etc. if a player decides to cash out or convert playing credits back into cash, tokens, bills, etc.

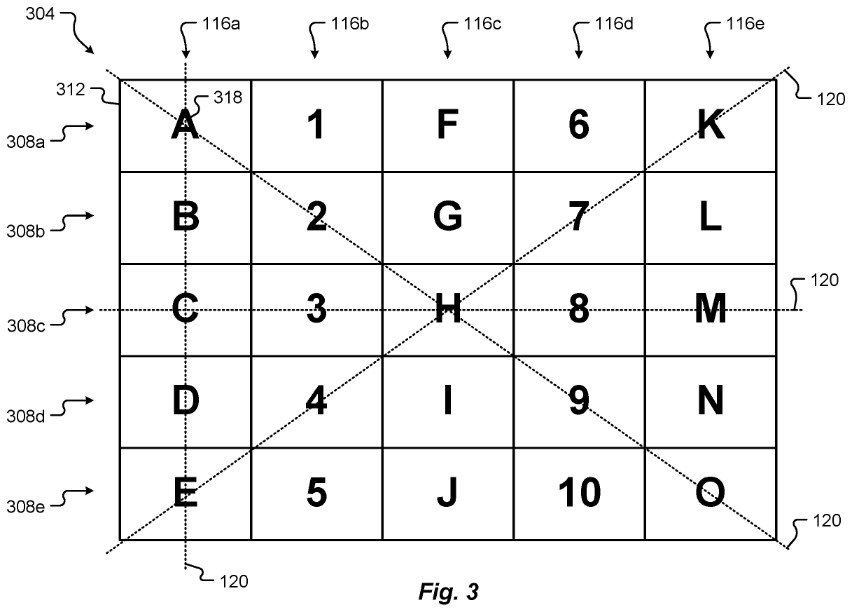

With reference now to FIG. 3, a first layout of symbols 318 rendered to an array of cells 304 of a grid-based game (e.g., a base game) will be described in accordance with embodiments of the present disclosure. The array of cells 304 may be presented, or otherwise rendered, with the display screen 104. In some embodiments, the game instruction set 220 may control which particular symbols 318 are presented within a particular cell 312 in the array of cells 304. The illustrative array of cells 304 is shown to include five columns 116a, 116b, 116c, 116d, 116e of cells 312 and five rows 308a, 308b, 308c, 308d, 308e of cells 312. Although FIG. 3 illustrates a 5×5 array of cells 304, it should be appreciated that embodiments of the present disclosure can be implemented in an array of cells 304 having a variety of sizes. For instance, embodiments of the present disclosure may be used in an array of cells 304 that are 3×3, 3×5, 5×3, 7×3, 10×5, 10×10, etc. The example layout of the array of cells 304 should not be construed as limiting embodiments of the present disclosure.

As can be seen in FIG. 3, each cell 312 in the array of cells 304 may be populated with a single symbol 318. In other words, after the game instruction set 220 has applied a random number generator 232 to determine symbol 318 placement throughout the array of cells 304, there will be a 1:1 correlation of symbols 318 to cells 312. Each column 116a, 116b, 116c, 116d, 116e may also be referred to as a reel 116, particularly in the event that the game instruction set 220 provides a slot game. If a slot game is implemented, then the reels 116 (e.g., in video form) are spun (e.g., virtually) and their final position after the spin is determined, at least in part, with assistance of the random number generator 232. In some embodiments, a symbol 318 may correspond to an absence of a symbol or a blank symbol. This blank symbol may correspond to a symbol in a cell 312 having no value.

In some embodiments, payouts or other predetermined game outcomes (e.g., bonus spin opportunities, prize wins, cash wins, re-spin bonus plays, etc.) may be determined based on a symbol combination that falls on a payline 120 that was subject to a wager prior to the spin. In some embodiments, a plurality of the paylines 120 may be selected for “play” prior to a spin, meaning that any payline 120 selected for “play” will be evaluated for a predetermined symbol combination, or sequence of symbols 318. Examples of a sequence of symbols 318 may include, but are in no way limited to, at least one of the sequence [A; 1; F; 6; K] associated with the first row 308a, the sequence [B; 2; G; 7; L] associated with the second row 308b, the sequence [C; 3; H; 8; M] associated with the third row 308c, the sequence [D; 4; I; 9; N] associated with the fourth row 308d, the sequence [E; 5; J; 10; O] associated with the fifth row 308e, and/or reverse sequences of the same. Additionally or alternatively, the sequence of symbols 318 may include, but are in no way limited to, a sequence of symbols 318 in an order along one or more of the vertical lines of cells 312 associated with the columns 116a-116e (e.g., the sequence [A; B; C; D; E], the sequence [1; 2; 3; 4; 5], etc., and/or reverse sequences of the same). In some embodiments, the sequence of symbols 318 may include, but are in no way limited to, a sequence of symbols 318 in an order along one or more of the cells 312 having a payline 120 running therethrough (e.g., the first diagonal payline sequence [A; 2; H; 9; 0], the second diagonal payline sequence [E; 4; H; 7; K], the first vertical payline sequence [A; B; C; D; E], the first horizontal payline sequence [C; 3; H; 8; M], etc., and/or reverse sequences of the same). In one embodiment, the sequence of symbols may comprise all sequences of symbols associated with each row 308a-308e and/or column 116a-116e. A selected payline 120 may also correspond to the payline 120 that is evaluated after symbols 318 have been subjected to a sliding symbol operation by the symbol slide instruction set 228. In some embodiments, however, it may be possible to switch or select more paylines 120 for evaluation after a spin has completed, but before a subsequent play operation (e.g., re-spin, etc.) has been performed. The addition of more paylines 120 after the original spin but prior to the subsequent play operation may require the user to provide more credits to the game instruction set 220 as part of enabling evaluation over more paylines 120. Although shown having four different linear paylines 120 (e.g., horizontal, vertical, diagonal, etc.), one or more paylines 120 may be associated with cells 312 in any shape the array of cells 304. In one embodiment, a payline 120 may run through a single row 308a-308e of the array of cells 304 (e.g., first row 308a, etc.). In some embodiments, a payline 120 may run through one or more columns 116a-116e in the array of cells 304. In any event, embodiments of the present disclosure are not limited to the position and/or shape of the paylines 120 shown in FIG. 3.

As provided above a game feature may correspond to any symbol, payline, multiplier, bonus, and/or other feature of the game that can be unlocked and enabled for a play of the game. By way of example, when the game feature is a special symbol (e.g., a scatter symbol, multiplier symbol, bonus symbol, etc.) and the player unlocks the special symbol for a play of the game, the special symbol may be caused to appear in any cell 312 in the array of cells 304 (e.g., via determination by the random number generator 232, etc.). In this example, when the special symbol appears in a predetermined winning cell location of the array of cells 304, the player may win a greater payout than if the special symbol were not unlocked for the play of the game. Stated another way, the player's chances of winning when the game feature is unlocked, or in an unlocked state, are greater than the chances of winning when the game feature is in a locked state. As another example, when the game feature is an additional payline and the player unlocks the additional payline for a play of the game, the additional payline may allow the player to win along the additional payline and/or the payline 120 when a sequence of winning symbols are generated for the cells 312 that fall along the additional payline and/or the payline 120. In some embodiments, the bonus and/or the multiplier types of game features may be applied to a result of the game and may not be specifically tied to a row 308a-308e, column 116a-116e, or cell 312 of the array of cells 304. In any event, the player's chances of winning when a game feature is in an unlocked state (e.g., unlocked) are greater than the player's chances of winning when the game feature is in a locked state (e.g., locked).

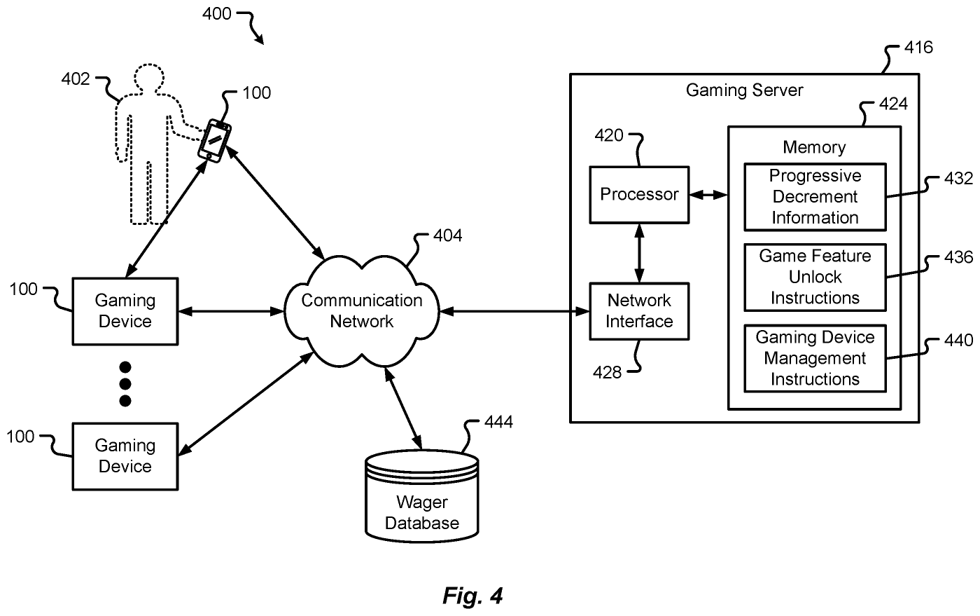

FIG. 4 is a block diagram of a competitive gaming system 400 for progressively decrementing unlock requirements for game features between linked gaming devices 100. The components of the competitive gaming system 400, while depicted as having particular instruction sets and devices, are not necessarily limited to the examples depicted herein. Rather, a system according to embodiments of the present disclosure may include one, some, or all of the components depicted in the system 400 and does not necessarily have to include all of the components in a single device. For instance, the components of a server may be distributed amongst a plurality of servers and/or other devices (e.g., gaming devices, EGMs, mobile devices, etc.) in the system 400 without departing from the scope of the present disclosure.

The competitive gaming system 400 is shown to include a communication network 404 that interconnects and facilitates machine-to-machine communications between one or multiple computational devices 100 (e.g., gaming devices, etc.) and a gaming server 416. In some embodiments, the gaming server 416 may be connected to a wager database 444 directly. In some embodiments, the gaming server 416 may receive wager information, via another server or computational device 100. It should be appreciated that the communication network 404 may correspond to one or many communication networks without departing from the scope of the present disclosure. In some embodiments, the computational devices 100 and server 416 may be configured to communicate using various nodes or components of the communication network 404. The communication network 404 may comprise any type of known communication medium or collection of communication media and may use any type of protocols to transport messages between endpoints. The communication network 404 may include wired and/or wireless communication technologies. The Internet is an example of the communication network 404 that constitutes an Internet Protocol (IP) network consisting of many computers, computing networks, and other communication devices located all over the world, which are connected through many telephone systems and other means. Other examples of the communication network 404 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 404 need not be limited to any one network type, and instead may be comprised of a number of different networks and/or network types. Moreover, the communication network 404 may comprise a number of different communication media such as coaxial cable, copper cable/wire, fiber-optic cable, antennas for transmitting/receiving wireless messages, and combinations thereof.

The gaming server 416 is shown to include a processor 420, memory 424, and a network interface 428. These resources may enable functionality of the gaming server 416 as will be described herein. For instance, the network interface 428 provides the server 416 with the ability to send and receive communication packets or the like over the communication network 404. The network interface 428 may be similar or identical to the network interface 212. Communications between the components of the server 416 and other devices connected to the communication network 404 may all flow through the network interface 428. In some embodiments, the processor 420 may also be similar or identical to the processor 204. In other words, the processor 420 may correspond to one or many microprocessors, CPUs, microcontrollers, or the like. The processor 420 may be configured to execute one or more instruction sets 436, 440 stored in memory 424.

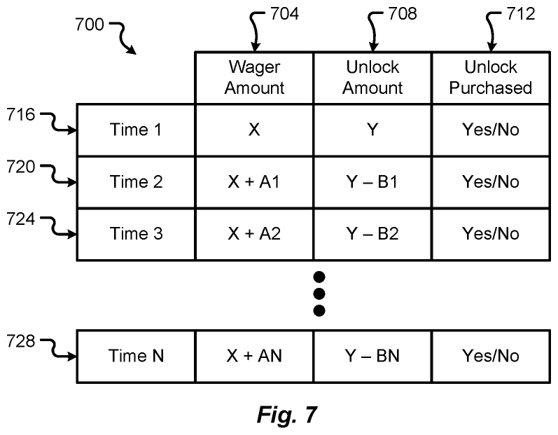

The memory 424 may store various data and instruction sets that allow the gaming server 416 to manage spin options, receive wagers, and cause the presentation of offers to unlock and activate game features for a spin to be rendered to one or more computational devices 100. Examples of the data may include, but are in no way limited to, progressive decrement information 432. The progressive decrement information 432 may comprise information on wagers made by one or more users 402 (e.g., players in the competitive gaming system 400, etc.), wager pools, and decrement amounts that are based on the same. In one embodiment, the progressive decrement information 432 may comprise information from the wager database 444. In some embodiments, the progressive decrement information 432 may comprise a mathematical relationship between the amount of wagers in a wager pool and a corresponding decrement amount to be applied to a predetermined amount required to unlock a game feature. Examples of the relationship between wagers made and decrement amounts are further described in conjunction with FIGS. 6 and 7. Illustrative instruction sets that may be stored in the memory 424 include, without limitation, a game feature unlock instruction set 436 and a gaming device management instruction set 440. Functions of the server 416 enabled by these various instruction sets will be described in further detail herein. It should be appreciated that the instruction sets depicted in FIG. 4 may be combined (partially or completely) with other instruction sets or may be further separated into additional and different instruction sets, depending upon configuration preferences for the server 416. Stated another way, the particular instruction sets depicted in FIG. 4 should not be construed as limiting embodiments described herein.

The game feature unlock instruction set 436, when executed by the processor 420, may enable the gaming server 416 to determine at least one of a game feature unlock offer to render to the computational device 100, manage a state of a game feature for a computational device 100, adjust (e.g., decrement or credit a credit meter 224 of a user 402 interacting with the computational device 100, and determine rules for the computational device 100 based on unlocking inputs received from a computational device 100. For instance, the computational device 100 may provide a first interactive gaming behavior comprising a first determined chances of winning for the base game while a game feature for the base game is in a locked state. Upon receiving an unlocking input (e.g., a user 402 providing an input at a particular computational device 100 comprising a predetermined amount from a credit meter 224 that unlocks a game feature), the game feature unlock instruction set 436 may unlock the game feature for the base game providing a second interactive gaming behavior comprising a second determined chances of winning for the base game greater than the first determined chances of winning when the game feature is in an unlocked state. If after a spin, no unlocking input is received, the game feature unlock instruction set 436 may decrement, based on wagers made in a game feature wager pool during plays of the base game, the predetermined amount to successively decreased values as long as the game feature remains in the locked state between each play of the plays of the game. The game feature unlock instruction set 436 may access, update, receive, and/or retrieve information from the wager database 444 and/or the progressive decrement information 432. The game feature unlock instruction set 436 may work in conjunction with the gaming device management instructions 440. In some embodiments, the game feature unlock instruction set 436 may be similar, if not identical, to the game feature unlock instruction set 228 described in conjunction with FIG. 2. Examples of the operations provided by the progressive decrement information 432 may be described in greater detail with respect to the methods of FIGS. 8 and/or 9.

The gaming device management instruction set 440, when executed by the processor 420, may control one or more features of the computational devices 100 based on wagers made by a user 402 and/or in response to input provided by a user 402 at the computational device 100. In some embodiments, these instructions and control may be made on the computational device 100. For instance, the control of the one or more features of the computational device 100 does not necessarily have to be communicated to the gaming server 416 or the gaming device management instruction set 440 running on the gaming server 416. In some embodiments, the gaming device management instruction set 440 may also be configured to track a status of game features unlocked and activated by a user 402. For instance, the gaming device management instruction set 440 may determine whether a user 402 of a specific computational device 100 has accepted an offer to unlock one or more game features for a spin or play of a base game at the specific computational device 100. Additionally or alternatively, the gaming device management instruction set 440 may store an outcome of games played and/or results of game feature unlocks made, or declined, in one or more data structures (e.g., stored in the progressive decrement information 432 and/or the wager database 444, etc.). In some embodiments, when an offer to unlock a game feature has not been accepted (e.g., no unlocking input is received), the gaming device management instruction set 140 may instruct the computational device 100 to render a subsequent offer to unlock the game feature for a reduced (e.g., decremented) amount. This amount may be based on wagers made in the game feature wager pool stored in the wager database 444 and/or decrement relationships defined and stored in the progressive decrement information 432. As provided above, the gaming device management instruction set 440 may work in conjunction with the game feature unlock instruction set 436.

The wager database 444 may maintain information corresponding to wagers made by one or more players at computational devices 100 in the competitive gaming system 400. In some embodiments, the wagers may be made as part of a game feature wager pool. As the amount of the wagers increases, the cost to unlock a particular game feature may decrease. This relationship may be inversely proportional such that the higher the wager the lower the cost to unlock a particular game. In some embodiments, the wagers for each play of a base game may be different but the cost reduction of the amount required as the unlocking input may be based on a total of all the wagers made in the wager pool.

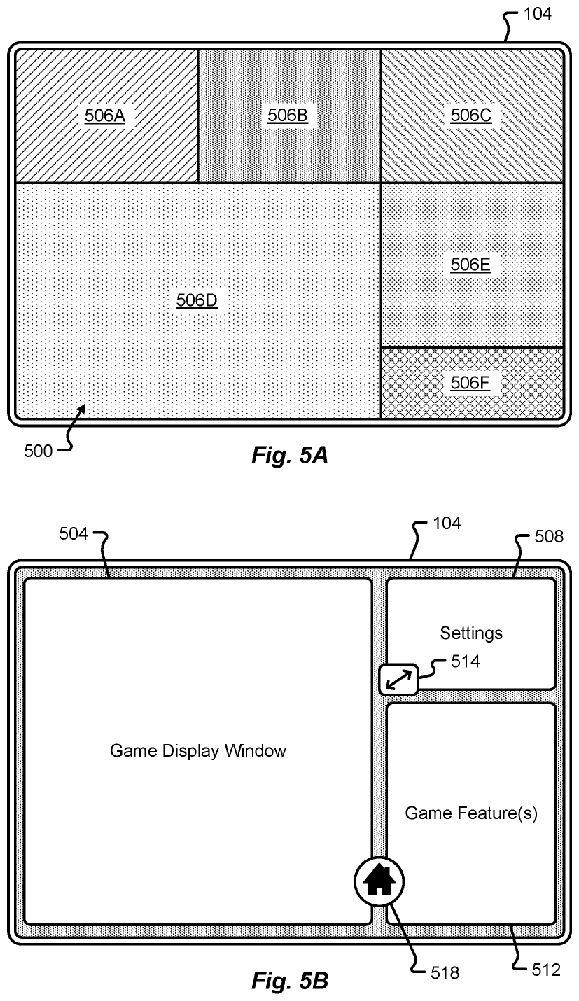

With reference now to FIGS. 5A-5B, representative images of a display screen 104 of a computational device 100 exhibiting various composite presentations are shown in accordance with at least some embodiments of the present disclosure. The display screen 104 may correspond to the user interface 216 of the computational device 100. The computational device 100 may render any casino game, arcade game, player information, and/or settings the display area 500 of the display screen 104. In some embodiments, the display screen 104 may include a background configured to display a background image. The display area 500 may be separated into two or more display portions 506A-506F, or areas. Although shown as including six different portions 506A-506F, it should be appreciated that the display area 500 may include a greater or fewer number of portions, in similar or different proportions and/or sizes, than illustrated in FIG. 5A. In addition, one or more windows, display elements, or interactive features may cross over one or more of the portions 506A-506F illustrated in FIG. 5A. Stated another way, a window may at least partially fill a single portion 506A-506F of the display area 500 or an area defined by multiple portions 506A-506F of the display area 500. By way of example, the game display window 504 shown in FIG. 5B may substantially fill an area of the display area 500 defined by the first portion 506A, the second portion 506B, and the fourth portion 506D, together, while the settings window 508 is shown as substantially filling the third portion 506C of the display area 500. Continuing with the example presentation shown in FIG. 5B, the game features window 512 may substantially fill an area of the display area 500 defined by the fifth portion 506E and the sixth portion 506F together.

In some embodiments, the user interface 216 of the computational device 100 may be configured to render, via the game instruction set 220 and/or the game feature unlock instruction set 228, a game display window 504, a settings window 508, and/or a game features window 512. Additionally or alternatively, the user interface 216 may be configured to render one or more other windows to the display area 500. As provided above, the display area 500 of the display screen 104 may be divided into separate, or discrete, areas or screen portions 506A-506F. It is an aspect of the present disclosure that the position of these areas may be moved, resized, minimized, superimposed, created, and/or removed, based at least part on player input and progress level reached. In one embodiment, a game may be rendered to the game display window 504 (e.g., provided by the game instruction set 220 executed by the processor 204, etc.). The game display window 504 may provide an area for a player to play a game (e.g., a grid-based game, etc.) associated with the computational device 100. The settings window 508 may provide a settings interface for a player to adjust settings of a game, and/or manage preferences of the player. The game features window 512 may allow a player to quickly identify one or more game features that can be, or are, unlocked. The game features window 512 may comprise information about unlocking input requirements (e.g., predetermined amounts for unlocking a game feature, decremented amounts for unlocking a game feature, etc.), whether a player (e.g., a user 402 in the competitive gaming system 400, etc.) has unlocked a game feature, remaining time on an activated game feature, and/or render selection options to unlock a game feature for a game, etc. In some embodiments, accepting an option to unlock a game feature may automatically transfer and/or decrement a credit (e.g., corresponding to the predetermined amount required to unlock the game feature, etc.) from a player's credit meter 224. In one embodiment, this credit may be transferred to, and/or updated by, the gaming server 416.

In addition to the separate windows 504, 508, 512, the display area 500 may include interface elements that manipulate or alter a size and/or position of the windows and/or a navigation between applications running on the computational device 100. For example, the display area 500 may include one or more window manipulation buttons 514. As shown in FIG. 5B, the window manipulation button 514 is illustrated in a corner of the settings window 508. Although shown in this location, it should be appreciated that the window manipulation button 514 may be rendered to any portion or combination of portions of the display area 500. In some embodiments, the window manipulation button 514 may cause a particular window to expand, contract, move, or otherwise resize. Additionally or alternatively, the window manipulation button 514 may cause one window to swap positions with another window rendered to the display area 500. For instance, as shown in FIG. 5B, a player may select the window manipulation button 514 to swap the game display window 504 with the settings window 508 such that the content associated with the settings window 508 is moved and resized (e.g., expanded) to be shown in the first portion 506A, second portion 506B, and fourth portion 506D of the display area 500 together (e.g., taking the place of the game display window 504). In this example, the content of the game display window 504 may move and resize (e.g., shrink) into the third portion 506C (e.g., taking the place of the settings window 508). In some embodiments, the display area 500 includes a navigation button 518 shown spanning over a portion of the game display window 504 and the hardware unlocked window 512. Although shown in this location, it should be appreciated that the navigation button 518 may be rendered to any portion or combination of portions of the display area 500. The navigation button 518 may provide a player with the ability to navigate between applications or games, close windows, move windows off screen, and/or otherwise move among programs running on the computational device 100.

FIGS. 6A and 6B illustrate various windows 600A, 600B providing game feature unlock information and player-selectable options to unlock and activate a game feature for a base game in accordance with embodiments of the present disclosure. The presentations shown in FIGS. 6A and 6B are provided as nonlimiting examples of player interaction in providing a selection and/or unlocking input. It should be appreciated that a player may provide the selection and/or unlocking input via any GUI, button, or other input device 108 of the computational device 100 in unlocking a game feature for the base game, and is not limited to the presentations shown in FIGS. 6A and 6B.

In FIG. 6A a first window 600A is shown providing game feature unlock information and player-selectable options to unlock and activate a game feature for a base game in accordance with embodiments of the present disclosure. The first game feature unlock window 600A may be configured as a pop-up window, menu, full-screen presentation, partial-screen presentation, etc., and/or combinations thereof, that are rendered by the user interface 216 (e.g., the display screen 104, etc.). The first game feature unlock window 600A provides an information presentation and selection area comprising options for a player to select one or more game features to unlock for a predetermined amount that is based on a wager amount made. The first game feature unlock window 600A may include one or more window manipulation buttons 602. As shown in the top right-hand corner of the first game feature unlock window 600A, the window manipulation button 602 may provide a button that, when selected, by a player closes the first game feature unlock window 600A.

The first game feature unlock window 600A may include information about game features, costs to unlock the game features, and changes to the costs over time (e.g., progressively reducing the cost as wagers are made and while the game feature remains locked). This information may be arranged to include, as shown in the header 604, a game feature type that is available (e.g., shown in the “Game Feature” column), a predetermined amount required to unlock a particular game feature (e.g., shown in the “Unlock Amount” column), and an locked/unlocked state of a particular game feature (e.g., shown in the “Unlocked” column) for a particular time as a game is played on the computational device 100. By way of example, the first unlock information row 608A shows that the game feature “Bonus Type 1” was available to be unlocked for “20 Credits” at a first time, but was not unlocked by any player (e.g., as represented by an “X” in the selection box of the “Unlocked” column). In the second unlock information row 608B, the first game feature unlock window 600A shows that the game feature “Bonus Type 1” was available to be unlocked for a first decremented amount of “15 Credits” at a second subsequent time, but again was not unlocked by any player. As described herein, a player may provide an unlocking input via a user selection icon in a player selection input area 612 of the first game feature unlock window 600A. In FIG. 6A, a player has selected to unlock the game feature of “Bonus Type 1” for the successively reduced amount of “8 Credits,” as indicated by the player input indicator 616 shown clicking the “Yes” icon. As a result, the status of the game feature is shown as unlocked as indicated by the checkmark in the selection box of the “Unlocked” column. When the player provides the unlocking input in the example above, the amount of “8 Credits,” corresponding to the successively reduced value for the predetermined amount required to unlock the game feature, is provided as a credit from a credit meter 224 associated with the player. In the event that the player did not select the “Yes” icon, and no other player provided an unlocking input, the game feature would remain in a locked state for the instant play and the game feature unlock amount may be further reduced for a subsequent play.

FIG. 6B shows a second window 600B providing game feature unlock information and player-selectable options to unlock and activate a game feature for a base game. In FIG. 6B, a “Press to Buy Bonus” selection button 620 is shown rendered to a portion of the display screen 104 of the computational device 100. When the selection button 620 is selected by as player as indicated by the player input indicator 616, the second game feature unlock window 600B may be caused to render to the display screen 104. Similar to the first game feature unlock window 600A, the second game feature unlock window 600B may comprise a window manipulation button 602 that, when selected by a player, closes the second game feature unlock window 600B. In some embodiments, the second game feature unlock window 600B may comprise an informational area 624 providing the cost of a bonus, a “Return to Game” option button, and an “Insert Credit” button. In one embodiment, the cost of the bonus (e.g., 4000 credits, etc.) may be shown on some portion of the screen (e.g., in the second game feature unlock window 600B, etc.). Once the second game feature unlock window 600B is invoked, by pressing the selection button 620 information regarding the game features, modifiers, etc., and the associated values may be provided to the informational area 624. As provided herein, the costs or values may decrement over time.

In some embodiments, a player may press the selection button 620 (or a shop button, etc.), which then offers the player the option to buy the game feature (e.g., the locked game feature, etc.) for a certain amount of money or credits. As illustrated in the example shown in FIG. 6B, when the player clicks or presses the selection button 620, the player may be presented with the second game feature unlock window 600B showing that 4000 credits are required to unlock the game feature at a first time. While the player is playing the base game, the 4000 credit unlock requirement may be shown in some portion of the display screen 104 and this value, or cost, may reduce over time (e.g., for each game played and/or wager made, etc.). Continuing this example, when the player presses the selection button 620 sometime after the first time, the player may be presented with the second game feature unlock window 600B showing that the 4000 credit requirement has been reduced to, for example, 3750 credits at a second time.

FIG. 7 is a block diagram of a data structure 700 used in progressively decrementing unlock requirements for game features in a base game in accordance with embodiments of the present disclosure. It should be appreciated that the data structure 700 depicted and described herein may be stored within a central database or may be distributed among a number of data storage nodes. Additionally or alternatively, some or all of the fields of the data structure may be maintained in devices of the competitive gaming system 400 such as the computational device 100, the gaming server 416, and/or the wager database 444 without departing from the scope of the present disclosure. In some embodiments, the progressive decrement data structure 700 may be stored in at least one of the memory 208 of the computational device 100, the memory 424 of the gaming server 416, and/or the wager database 444.

As a non-limiting example, the progressive decrement data structure 700 may be used to store information about wagers made, game feature unlock costs, game feature unlock statuses, mathematical relationships, and the like, over time. Even more specifically, the progressive decrement data structure 700 may include a plurality of data fields that include, for instance, a wager amount field 704, an unlock amount field 708, and an unlock purchased field 712.

The wager amount field 704 may be used to store historical data for wagers made by players of a computational device 100. The wagers may be made via a particular computational device 100 and may be related to one or more games. The wager amount field 704 may include information describing wagers made for a game over time including, but in no way limited to, one or more of a wager type, a wager or bet amount, a total amount of wagers made for a point in time, etc., and/or combinations thereof. The information stored in the wager amount field 704 may include a timestamp for each wager made, for example, defining when the wager was made. The timestamps may be used to determine timing associated with wagers made while playing a base game at a computational device 100, a game play to which the wager applies, organizing data, and/or the like. The information in the wager amount field 704 may be used to track a history of wagers in which a particular player participated. In some embodiments, the information stored in the wager amount field 704 may be received from player input provided via a computational device 100 and/or the gaming server 416.

The unlock amount field 708 may be used to store an unlock amount for a particular game feature over time. The unlock amount may correspond to a predetermined amount that, when provided as a credit received from a credit meter 224, unlocks the game feature for the base game (e.g., for the computational device 100 providing the unlock amount). In some embodiments, the unlock amount may be provided as an unlocking input provided at a user interface 216 of a computational device 100. The unlock amount may be tied to the wager amount stored in the wager amount field 704. In one embodiment, a default predetermined amount may be associated with a first unlock amount required to unlock a particular game feature. This default predetermined amount may correspond to an unlock amount that has not been decremented, or successively decreased, based on wagers made during plays of a game.

In some embodiments, the progressive decrement data structure 700 may comprise an unlock purchased field 712 that may be used to store whether a particular game feature was unlocked at a given time. Although shown as a “Yes” or “No” option, the data stored in the unlock purchased field 712 may additionally, or alternatively, define whether an offer to unlock a particular game feature (e.g., as shown in the game feature unlock window 600, etc.) was at least one of accepted, ignored, declined, automatically activated (e.g., when the unlock amount reaches zero, etc.), and/or otherwise disposed of.

Since the progressive decrement data structure 700 may be configured to store information for one or more game features over time, the progressive decrement data structure 700 may have multiple entries for each point in time that a game is played or a wager is made. The progressive decrement data structure 700 may be arranged to have multiple time entries, represented as time rows 716-728, when the game feature is not unlocked at a first time. As shown in the first time row 716 of the progressive decrement data structure 700, the wager amount is “X,” which may correspond to any positive number. In one embodiment, the first time row 716 may correspond to the initial information for a game feature (e.g., before any reduction in cost, etc.). The unlock amount shown in first time row 716 may be “Y,” which may correspond to a nonzero positive credit value associated with the default predetermined amount required to unlock a particular game feature for a base game. In the example shown in the first game feature unlock window 600A of FIG. 6A, the unlock amount of the first unlock information row 608A may correspond to the unlock amount from the first time row 716 of the progressive decrement data structure 700 of FIG. 7. For instance, the unlock amount “Y” may be initially set to “20 Credits.”

In the second time row 720, the wager amount has increased by a positive amount to equal the value of “X” plus a first additional amount of “A1.” Because the wager amount for a game that is tied to a particular game feature has increased, and the game feature was not unlocked at the first time, the unlock amount may be decremented, or reduced, at the second time from the value of “Y” or to the value of “Y” minus a first decrement value of “B1.” In the example shown in the first game feature unlock window 600A of FIG. 6A, the unlock amount of the second unlock information row 608B may correspond to the unlock amount from the second time row 720 of the progressive decrement data structure 700 of FIG. 7. For instance, the unlock amount “Y” of “20 Credits” has been reduced by a value of B1, which in this example is five credits, to yield an unlock amount at the second time of “15 Credits.”

The third time row 724 shows that the wager amount has increased, yet again, by a positive amount equal to the value of “X” plus a second additional amount of “A2,” where “A2” is greater than “A1.” In this case, since the wager amount for the game is tied to a particular game feature and that wager amount has increased (and because the game feature was not unlocked at the second time) the unlock amount may be successively reduced at the third later time from the value of “Y” or “Y-B1” to the value of “Y” minus a second decrement value of “B2,” wherein B2 is greater than B1. In the example shown in the first game feature unlock window 600A of FIG. 6A, the unlock amount of the third unlock information row 608C may correspond to the unlock amount from the third time row 724 of the progressive decrement data structure 700 of FIG. 7. For instance, the unlock amount “Y” of “20 Credits” has been reduced by a value of B2, which in this example is twelve credits, to yield an unlock amount at the third time of “8 Credits.”

If, at the third time, the game feature is not unlocked the unlock amount may be further successively reduced until the unlock purchased status changes to unlocked, as illustrated by the data in the Nth time row 728, where “AN” is greater than “A1” and “A2,” and where “BN” is greater than “B1” and “B2.” In some embodiments, successively reducing the unlock amount over time may be based on a percentage of increase to the wager amount over time. For example, if the wager amount increases by 20% between the first time and the second time, the unlock amount may be reduced by 20%. Other mathematical relationships between the wager amounts and the reduction in the unlock amount may be used as long as the game feature remains locked, the wager amount increases, and the unlock amount is successively reduced each subsequent time.

Referring to FIG. 8, a flow diagram depicting a method of an example process for progressively decrementing unlock requirements for game features in a base game is shown in accordance with embodiments of the present disclosure. The methods described herein may be run as a set of instructions on a computational device 100 and/or some other server (e.g., gaming server 416, etc.) in communication with the computational device 100. In some embodiments, the set of instructions may be part of an application installed on the computational device 100 and/or the gaming server 416. In any event, the method begins by executing a base game (e.g., a grid-based game, etc.) at the computational device 100 (e.g., gaming device) (step 804). In step 804, the base game may provide a first interactive gaming behavior with a first determined chances of winning for the base game while a game feature for the base game is in a locked state. Stated another way, in step 804, the game feature has not been unlocked. In one embodiment, This step may occur in response to the player selecting a predetermined button or providing an input via some other input device 108, inserting coins, cash, tickets, vouchers, etc., or performing some other action at the computational device 100 that indicates a desire to begin game play. In one embodiment, the first input may correspond to an input provided by the player via an input device 108. For example, the first input may correspond to a button press, a touch of a screen, a lever actuation, a gesture, and/or some other physical input provided by the player. The grid-based game may correspond to a reel-spin game, a matching game, and/or any other game having a sequence of symbols 318 arranged in a presentation order.

The method may continue by generating a first sequence of symbols for the first play of the base game. In some embodiments, the game instruction set 220 initiating the first play (e.g., a first reel spin) may leverage the random number generator 232 to determine a final position of symbols 318 to be rendered in the array of cells 304. The grid-based game may be arranged as an array of cells 304 having a specific presentation order that defines a specific position of each cell 312 in the array of cells 304 relative to one another. The symbols 318, including the particular symbol associated with the sliding symbol operation, are rendered in the array of cells 304 via the display screen 104 of the computational device 100. The randomly-generated first sequence of symbols 318 may be rendered to the array of cells 304 such that each cell 312 in the array of cells 304 comprises a discrete symbol 318 in the first sequence of symbols 318. A discrete symbol may comprise any symbol, including a blank symbol, associated with the grid-based game that has been randomly generated for a specific cell 312 in the array of cells 304 from a predetermined group of symbols 318.

The method continues by maintaining the game feature for the base game in the locked state until an unlocking input is received (step 808). The unlocking input may include a predetermined amount that, when provided as a credit received from a credit meter 224, unlocks the game feature for the base game. The game feature, when unlocked (e.g., in an unlocked state) may provide a second interactive gaming behavior comprising a second determined chances of winning for the base game greater than the first determined chances of winning when the game feature. This second interactive gaming behavior may include incorporating special symbols into a game play, applying multipliers to outcomes of a game play, and/or allowing additional ways to win a game play.

Next, the method proceeds by decrementing, based on wagers made in a feature pool during plays of the base game, the predetermined amount to successively decreased values as long as the game feature remains in the locked state between each play of the plays of the game (step 812). At every play of the game, the method may determine whether an unlocking input has been provided. In a multiple-player linked gaming system, this step may include determining whether any player in the competitive gaming system 400 has provided an unlocking input for the game feature. As long as no unlocking input is received, the method may continue to decrement the predetermined amount. In some embodiments, the method may decrement the predetermined amount until the decreased value reaches zero. Once the cost to unlock the game feature reaches zero, the game feature may be automatically unlocked and activated for a subsequent play of the base game. In some embodiments, the game feature may be unlocked for a player who has wagered the most out of a number of players in the competitive gaming system 400 (e.g., the highest value contributed to the feature pool, etc.). In one embodiment, the game feature may be unlocked for a randomly selected player.

While the game feature remains in the locked state between each play of the plays of the game, the method may proceed by causing a display screen 104 of the computational device 100 executing the base game to render a last successively decreased value for the predetermined amount to unlock the game feature for the base game (step 816). In some embodiments, the last successively decreased value may be presented as part of a game feature unlock window 600. The information rendered by the display screen 104 may provide an option for a player to provide an unlocking input by accepting the last successively decreased value for unlocking the game feature for a subsequent game play.

The method may receive, after the predetermined amount has been decremented at least once, the unlocking input for the predetermined amount from the credit meter 224 associated with a player of the base game at the computational device 100 (step 820). The unlocking input may be provided by the player providing a selection input via the user interface 216 and accepting the last successively decreased value for unlocking the game feature for a subsequent game play. In response to receiving the unlocking input, the method may continue by activating the game feature for at least one play of the base game at the computational device 100. Activating the game feature may comprise changing the status of the game feature from a locked state to an unlocked state and then executing the base game at the computational device 100 with the game feature providing the second interactive gaming behavior with the second determined chances of winning for the base game that are greater than the first determined chances of winning without the game feature. Depending on the type of game feature, the game feature may be activated for one or multiple plays.

Next, the method proceeds by resetting the predetermined amount to a value prior to decrementing to at least one of the successively decreased values (step 828). The reset value of the predetermined amount required to unlock the game feature may be the initial or default predetermined amount for unlocking the game feature before any reduction in cost. In some embodiments, the value of the predetermined amount required to unlock the game feature value may be reset while the game feature is activated and in the unlocked state for the computational device 100 and/or at least one player in the competitive gaming system 400. In some embodiments, the computational device 100 having the game feature unlocked and activated may be prevented from further game feature unlocks until the game feature activation expires (e.g., based on time, number of plays, wins, etc.).

Referring now to FIG. 9, a flow diagram of a second example process for progressively decrementing unlock requirements for game features in a base game is shown in accordance with embodiments of the present disclosure. The methods described herein may be run as a set of instructions on a computational device 100 and/or some other server (e.g., gaming server 416, etc.) in communication with the computational device 100. In some embodiments, the set of instructions may be part of an application installed on the computational device 100 and/or the gaming server 416.

The method begins by executing a base game (e.g., a grid-based game, etc.) at the computational device 100 (e.g., gaming device) (step 904). Step 904 may be similar, if not identical, to step 804 as described in FIG. 8. In some embodiments, step 904 may correspond to executing a base game providing the first interactive gaming behavior with the first determined chances of winning for the base game after not providing an unlocking input for a game feature (and while the game feature remains in a locked state). This step may correspond to a first game play, a second game play, or some other subsequent game play where a game feature remains in a locked state for the base game.

The method may proceed by maintaining the game feature for the base game in the locked state until an unlocking input is received (step 908). Maintaining the game feature for the base game may comprise continuing to provide the first interactive gaming behavior with the first determined chances of winning for the base game.

Next, the method continues by determining whether an unlocking input is received for the game feature (step 912). The unlocking input may include a predetermined amount that, when provided as a credit received from a credit meter 224, unlocks the game feature for the base game. In some embodiments, the unlocking input may be provided by a player providing a selection input at the computational device 100. In one embodiment, the unlocking input may be provided by any player in the competitive gaming system 400. For example, while a player is playing the base game at a first computational device 100, another player may provide the unlocking input at another computational device 100. In some embodiments, the gaming server 416 may receive the unlocking input.

When the unlocking feature is not received the method may proceed by decrementing the predetermined amount required to unlock the game feature by a decreased value (step 916). The decreased value may be based on an amount of wagers made for the game. These wagers may be based on a single player or multiple players that are making wagers in a feature pool. As the wagers increase the decrementing amount applied to the predetermined amount also increase, resulting in a lower cost for unlocking the game feature. In response to decrementing the predetermined amount, the method may continue by causing a display screen 104 of the computational device 100 executing the base game to render the decreased value for the predetermined amount to unlock the game feature for the base game (step 920). In some embodiments, the decreased value may be presented as part of a game feature unlock window 600. The information rendered by the display screen 104 may provide an option for a player to provide an unlocking input by accepting the decreased value for unlocking the game feature for a subsequent game play. The method may return to step 904 and continue as described above.

In the event that an unlocking input is received at step 912, the method may proceed by resetting the predetermined amount to a previously undecremented value (step 924). The previously undecremented value may correspond to the initial or default predetermined amount for unlocking the game feature (e.g., before any reduction in cost has been made according to the method). In some embodiments, the value of the predetermined amount required to unlock the game feature value may be reset while the game feature is activated and in the unlocked state for the computational device 100 and/or at least one player in the competitive gaming system 400. In some embodiments, the computational device 100 having the game feature unlocked and activated may be prevented from further game feature unlocks until the game feature activation expires (e.g., based on time, number of plays, wins, etc.). While the computational device 100 is prevented from accepting or participating in further game feature unlocks (e.g., as long as the game feature is active for the computational device 100), other players in the competitive gaming system 400 may continue to play games and continue the method from step 904.

The method may proceed by unlocking and activating the game feature for the computational device 100 and/or player providing the unlocking input (step 928). Unlocking the game feature may comprise updating the progressive decrement data structure 700 and/or the progressive decrement information 432 indicating that the unlock purchase was made by a particular player, for a particular amount, at a particular time. Activating the game feature may comprise changing the status of the game feature from a locked state to an unlocked state and then executing the base game at the computational device 100 with the game feature providing the second interactive gaming behavior (step 932). The second interactive gaming behavior provided by the gaming feature includes the second determined chances of winning for the base game that are greater than the first determined chances of winning without the game feature. In some embodiments, the second interactive gaming behavior may include incorporating special symbols into a game play, applying multipliers to outcomes of a game play, and/or allowing additional ways to win the base game.

The method may proceed by determining whether the activation of the unlocked game feature has expired (step 936). In some embodiments, the game feature may only be active for a specific number of game plays, a specific amount of time, and/or as long as a winning outcome has not been reached. As long as the activation of the game feature has not expired, the game feature will remain unlocked for the computational device 100 and the method may continue to execute the game according to the second interactive gaming behavior (step 932). However, when the activation of the game feature expires, the method may return to step 904 and repeat one or more of the steps outlined above.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A gaming device, comprising:
a display device;
a processor coupled to the display device; and
a memory coupled with and readable by the processor and storing therein instructions that, when executed by the processor, cause the processor to:
execute a base game at the gaming device that provides a first interactive gaming behavior comprising a first determined chances of winning for the base game while a game feature for the base game is in a locked state;
maintain the game feature for the base game in the locked state until an unlocking input is received comprising a predetermined amount that, when provided as a credit received from a credit meter, unlocks the game feature for the base game, wherein the game feature provides a second interactive gaming behavior comprising a second determined chances of winning for the base game greater than the first determined chances of winning when the game feature is in an unlocked state;
decrement, based on wagers made in a feature pool during plays of the base game, the predetermined amount to successively decreased values as long as the game feature remains in the locked state between each play of the plays of the game; and
render, by the display device at each play of the plays of the game, a last successively decreased value for the predetermined amount to unlock the game feature for the base game.

2. The gaming device of claim 1, wherein the instructions, when executed by the processor, further cause the processor to:
receive, after the predetermined amount is decremented at least once, the unlocking input for the predetermined amount from the credit meter, wherein the credit meter is associated with a player of the base game at the gaming device.

3. The gaming device of claim 2, wherein the instructions, when executed by the processor, further cause the processor to:
activate, in response to receiving the unlocking input, the game feature for at least one play of the base game at the gaming device.

4. The gaming device of claim 3, wherein the instructions, when executed by the processor, further cause the processor to:
reset, while the game feature is activated and in the unlocked state, the predetermined amount to a value prior to decrementing to at least one of the successively decreased values.

5. The gaming device of claim 1, wherein the feature pool comprises totals of wagers made during plays of the base game, and wherein the decrement is proportionate to the totals of wagers made.

6. The gaming device of claim 5, wherein the wagers made in the feature pool are placed by a plurality of gaming devices linked to one another via a communication network, and wherein the plurality of gaming devices comprises the gaming device.

7. The gaming device of claim 6, wherein the instructions, when executed by the processor, further cause the processor to:
receive, after the predetermined amount is decremented at least once, the unlocking input for the predetermined amount from the credit meter, wherein the credit meter is associated with a player at an alternative gaming device of the plurality of gaming devices, and wherein the alternative gaming device is different from the gaming device; and
reset, while the game feature is activated and in the unlocked state, the predetermined amount to a value prior to decrementing to at least one of the successively decreased values.

8. The gaming device of claim 7, wherein the instructions, when executed by the processor, further cause the processor to:
decrement, after resetting the predetermined amount and based on additional wagers made in the feature pool during subsequent plays of the base game, the predetermined amount to further successively decreased values as long as the game feature remains in the locked state between each play of the plays of the game for each of the plurality of gaming devices excluding the alternative gaming device; and
render, by the display device at each play of the subsequent plays of the game, a last further successively decreased value for the predetermined amount to unlock the game feature for the base game.

9. The gaming device of claim 1, wherein the game feature is at least one of a multiplier, a scatter symbol, a mini-game, a free spin, a chance at a progressive, a chance at a jackpot, a wild symbol, an additional payline, an additional reel, and a bonus.

10. The gaming device of claim 1, wherein the plays of the game comprise an uninterrupted and continuous gaming session by a single player at the gaming device.

11. A method, comprising:
executing, by a processor, a base game at a gaming device that provides a first interactive gaming behavior comprising a first determined chances of winning for the base game while a game feature for the base game is in a locked state;
maintaining, by the processor, the game feature for the base game in the locked state until an unlocking input is received comprising a predetermined amount that, when provided as a credit received from a credit meter, unlocks the game feature for the base game, wherein the game feature provides a second interactive gaming behavior comprising a second determined chances of winning for the base game greater than the first determined chances of winning when the game feature is in an unlocked state;
decrementing, by the processor and based on wagers made in a feature pool during plays of the base game, the predetermined amount to successively decreased values as long as the game feature remains in the locked state between each play of the plays of the game; and
causing to render, by a display device of the gaming device at each play of the plays of the game, a last successively decreased value for the predetermined amount to unlock the game feature for the base game.

12. The method of claim 11, further comprising:
receiving, by the processor after the predetermined amount is decremented at least once, the unlocking input for the predetermined amount from the credit meter, wherein the credit meter is associated with a player of the base game at the gaming device.

13. The method of claim 12, further comprising:
activating, by the processor in response to receiving the unlocking input, the game feature for at least one play of the base game at the gaming device.

14. The method of claim 13, further comprising:
resetting, by the processor while the game feature is activated and in the unlocked state, the predetermined amount to a value prior to decrementing to at least one of the successively decreased values.

15. The method of claim 11, wherein the feature pool comprises totals of wagers made during plays of the base game, and wherein the decrementing is proportionate to the totals of wagers made.

16. The method of claim 15, wherein the wagers made in the feature pool are placed by a plurality of gaming devices linked to one another via a communication network, and wherein the plurality of gaming devices comprises the gaming device.

17. The method of claim 16, further comprising:
receiving, by the processor, after the predetermined amount is decremented at least once, the unlocking input for the predetermined amount from the credit meter, wherein the credit meter is associated with a player at an alternative gaming device of the plurality of gaming devices, and wherein the alternative gaming device is different from the gaming device; and
resetting, by the processor while the game feature is activated and in the unlocked state, the predetermined amount to a value prior to decrementing to at least one of the successively decreased values.

18. The method of claim 17, further comprising:
decrementing, by the processor, after resetting the predetermined amount and based on additional wagers made in the feature pool during subsequent plays of the base game, the predetermined amount to further successively decreased values as long as the game feature remains in the locked state between each play of the plays of the game for each of the plurality of gaming devices excluding the alternative gaming device; and
causing to render, by the display device of the gaming device, at each play of the subsequent plays of the game, a last further successively decreased value for the predetermined amount to unlock the game feature for the base game.

19. A system, comprising:
a processor; and
a computer-readable storage medium, coupled with the processor, comprising instructions that are executable by the processor, wherein the instructions comprise:
instructions that execute a base game at a gaming device that provides a first interactive gaming behavior comprising a first determined chances of winning for the base game while a game feature for the base game is in a locked state;
instructions that maintain the game feature for the base game in the locked state until an unlocking input is received comprising a predetermined amount that, when provided as a credit received from a credit meter, unlocks the game feature for the base game, wherein the game feature provides a second interactive gaming behavior comprising a second determined chances of winning for the base game greater than the first determined chances of winning when the game feature is in an unlocked state;
instructions that decrement, based on wagers made in a feature pool during plays of the base game, the predetermined amount to successively decreased values as long as the game feature remains in the locked state between each play of the plays of the game; and
instructions that cause to render, by a display device at each play of the plays of the game, a last successively decreased value for the predetermined amount to unlock the game feature for the base game.

20. The system of claim 19, wherein the instructions further comprise:
instructions that receive, after the predetermined amount is decremented at least once, the unlocking input for the predetermined amount from the credit meter, wherein the credit meter is associated with a player of the base game at the gaming device;
instructions that activate, in response to receiving the unlocking input, the game feature for at least one play of the base game at the gaming device; and
instructions that reset, while the game feature is activated and in the unlocked state, the predetermined amount to a value prior to decrementing to at least one of the successively decreased values.
